(19) United States
(12) Patent Application Publication
(10) Pub. No.: US 2014/0021237 A1
(43) Pub. Date: Jan. 23, 2014

(54) SPRING BIASED LOCK FOR MAGAZINE OF NAIL GUN

(71) Applicant: Chin-Chin Chang, Taichung City (TW)

(72) Inventor: Chin-Chin Chang, Taichung City (TW)

(21) Appl. No.: 13/554,530

(22) Filed: Jul. 20, 2012

(51) Int. Cl. B25C 1/00

(52) U.S. Cl. 227/127

(57) ABSTRACT

A magazine of nail gun is provided with a nail receptacle; a cover slidably mounted on the receptacle; a cavity on an uneven bottom of the cover; a first hole from the cover to the cavity; a spring biased button in the first hole; a first retaining member secured to the button and urging against a bottom of the cavity so as to retain the button; a second hole through the receptacle and aligned with the first hole; a spring biased detent in the second hole and projecting out of the second hole to urge against a bottom of the button; and a second retaining member secured to the detent and urging against the bottom of the receptacle so as to retain the detent. The cover is locked by the receptacle in a storage position of the magazine.

### BACKGROUND OF THE INVENTION

1. Field of the Invention

The invention relates to nail gun components and more particularly to a spring biased lock for a magazine of a nail gun, the lock being adapted to unlock by pressing so that subsequently a cover of the magazine can be slid to open a receptacle thereof and nail thus can be stored in the receptacle.

2. Description of Related Art

There is a conventional pushing device for a drawer type magazine of a nail gun comprising a magazine unit including a fixed magazine coupled with a barrel, and a removable nail loading assembly; a pushing device including an accommodating member disposed in an accommodating part of the nail loading assembly, a spiral spring disposed at one end of the accommodating member and cooperated with a nail pusher, an engaging member inserted into the spiral spring and locked at one end of the accommodating member and a fastener inserted into a lock hole of the nail loading assembly and a penetrating end of the accommodating member; and a nail pusher disposed between the fixed magazine and the nail loading assembly and pushed by the pushing device.

Notwithstanding the prior art, the invention is neither taught nor rendered obvious thereby.

### SUMMARY OF THE INVENTION

It is therefore one object of the invention to provide a magazine of a nail gun comprising a receptacle for storing nails; a cover slidably mounted on the receptacle; a cavity formed on an uneven bottom of the cover; a first hole formed from a top of the cover to the cavity; an inclined surface extending from an edge of the cavity to the bottom of the cover; a spring biased button disposed in the first hole; a first retaining member secured to the spring biased button and urging against a bottom of the cavity so as to retain the spring biased button; a second hole formed from a top of the receptacle to an uneven bottom thereof and being aligned with the first hole; a spring biased detent disposed in the second hole and projecting out of the second hole to urge against a bottom of the button; and a second retaining member secured to the spring biased detent and urging against the bottom of the receptacle so as to retain the spring biased detent; wherein the cover is locked by the receptacle in a storage position; and whereby pressing the spring biased button until being stopped will disengage the first retaining member from the bottom of the cavity, disengage the second retaining member from the bottom of the receptacle, and cause the detent to clear the cavity, thereby unlocking the cover.

The above and other objects, features and advantages of the invention will become apparent from the following detailed description taken with the accompanying drawings.

### BRIEF DESCRIPTION OF THE DRAWINGS

FIG. 1 is a perspective view of a nail gun incorporating a spring biased lock for a magazine according to the invention;

FIG. 2 is a broken apart sectional view of the magazine;

FIG. 3 is an exploded view of the magazine;

FIG. 4 is a sectional view taken along line A-A of FIG. 1;

FIG. 5 is a sectional view taken along line B-B of FIG. 1;

FIG. 6 is a view similar to FIG. 5 showing a pressing of the button; and

FIG. 7 is a view similar to FIG. 6 showing a sliding movement of the cover to open the magazine; and

FIG. 8 is a perspective view of the nail gun corresponding to FIG. 7 showing nails to be stored in the magazine.

### DETAILED DESCRIPTION OF THE INVENTION

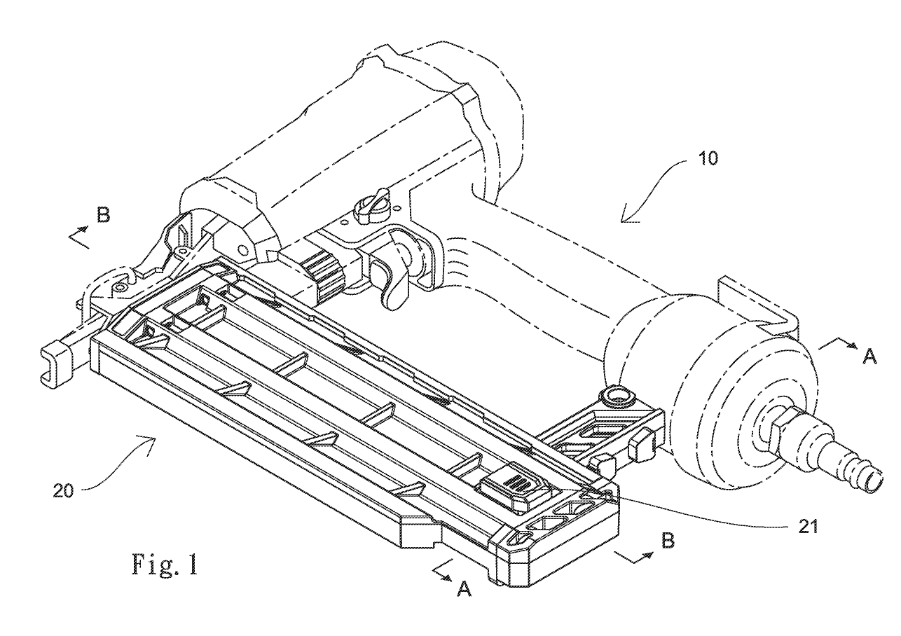

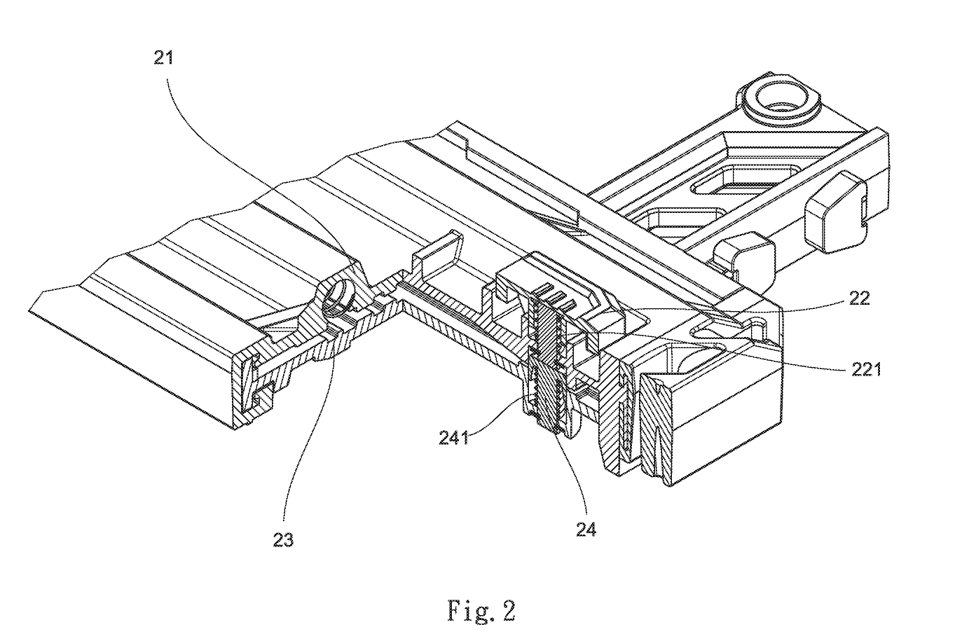

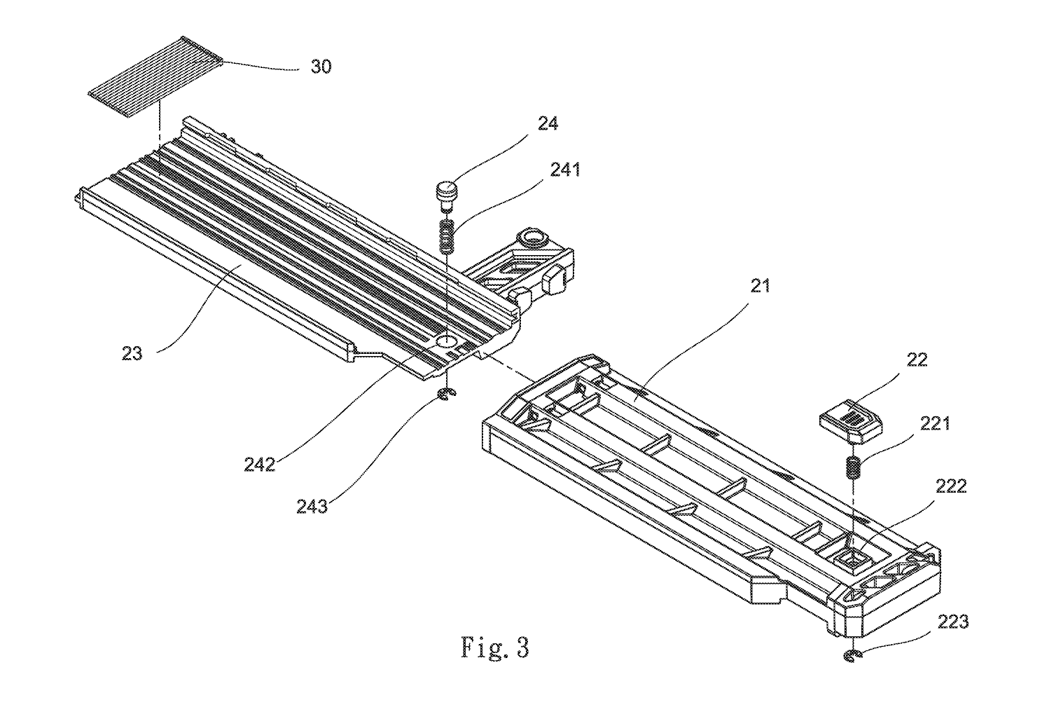

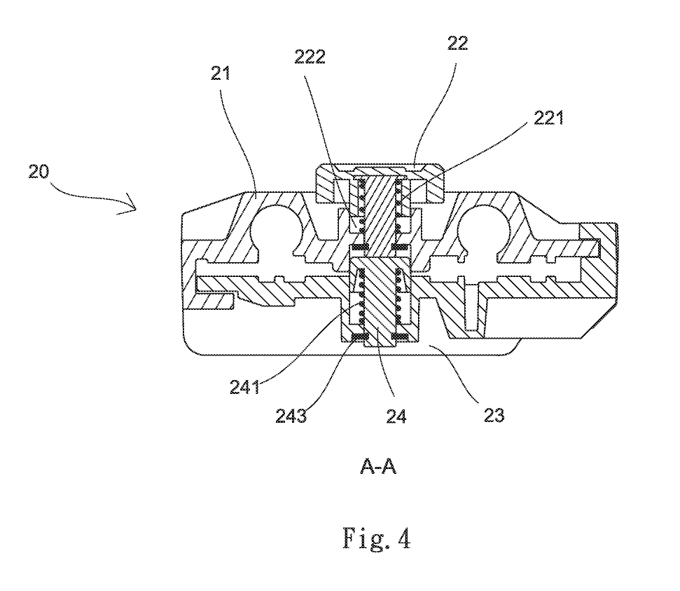

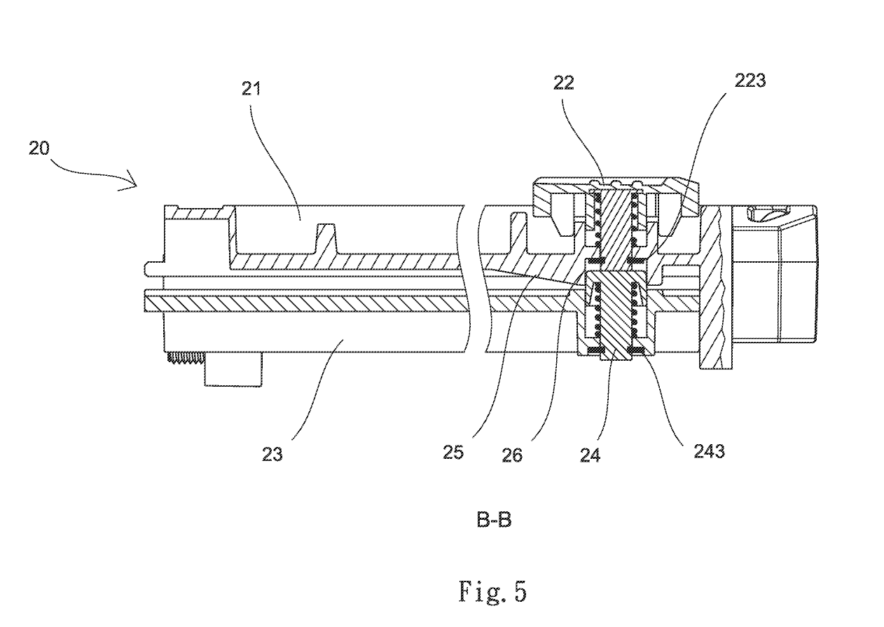

Referring to FIGS. 1 to 8, a spring biased lock for a magazine 20 of a nail gun 10 in accordance with the invention comprises the following components as discussed in detail below.

The magazine 20 is rectangular and comprises a receptacle 23 adapted to store nails 30; a cover 21 slidably mounted on the receptacle 23; a first hole 222 formed from a top of the cover 21 to a cavity 26 on an uneven bottom thereof, the first hole 222 being adjacent to a front end of the cover 21; an inclined surface 25 extending from an edge of the cavity 26 to the bottom of the cover 21; a helical first spring 221 anchored in the first hole 222; a button 22 disposed in the first hole 222 and having a T-shaped longitudinal section with the first spring 221 put on the vertical portion thereof; a first split ring 223 secured to the vertical portion of the button 22 and urging against a bottom of the cavity 26 so that the spring biased button 22 is retained in a storage position of the magazine 20; a second hole 242 formed from a top of the receptacle 23 to an uneven bottom thereof, the second hole 242 being adjacent to a front end of the receptacle 23; a helical second spring 241 anchored in the second hole 242; a detent 24 disposed in the second hole 242 and having a T-shaped longitudinal section with the second spring 241 put on the vertical portion thereof; and a second split ring 243 secured to the vertical portion of the detent 24 and urging against the bottom of the receptacle 23 so that the spring biased detent 24 is retained in the storage position of the magazine 20.

Further, in the storage position of the magazine 20, the first hole 222 is aligned with the second hole 242, and the detent 24 projects out of the second hole 242 to urge against a bottom of the button 22. Thus, the cover 21 and the receptacle 23 are lockingly fastened together.

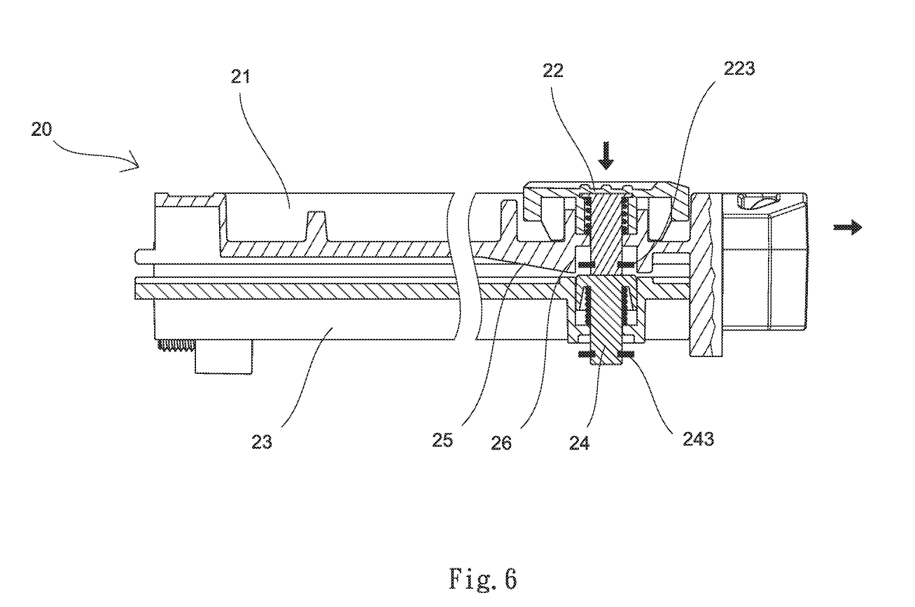

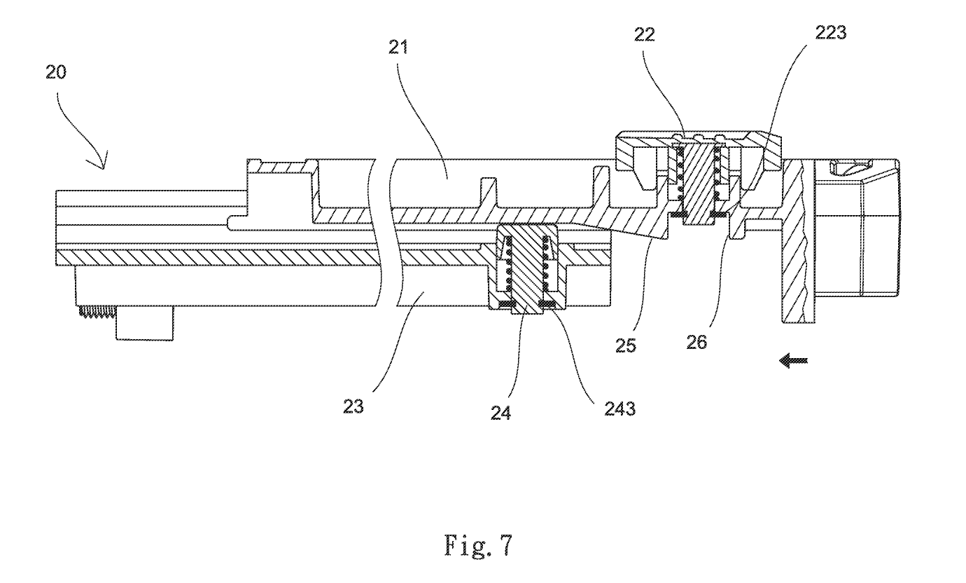

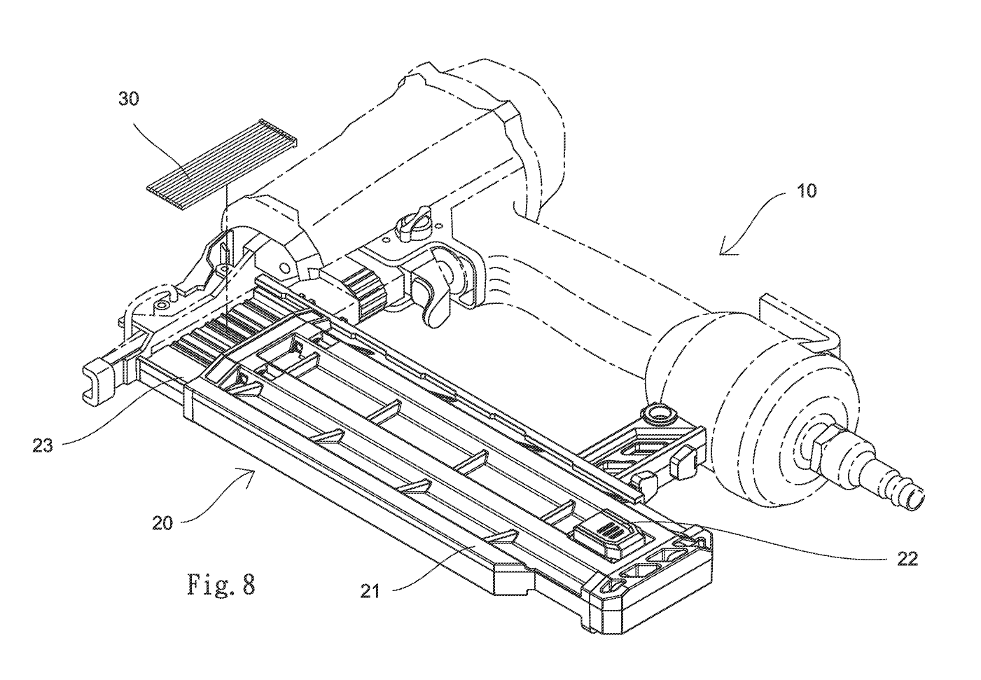

For storing the nails 30 in the magazine 20, a user may press the button 22 until being stopped (see FIG. 6). As shown, the first split ring 223 is disengaged from the bottom of the cavity 26, the second split ring 243 is disengaged from the bottom of the receptacle 23, and the detent 24 clears the cavity 26. Thus, the receptacle 23 is not locked by the cover 21. Next, the user may push the cover 21 rightward (see FIG. 6) until the inclined surface 25 completely passes the detent 24 (see FIG. 7). In FIG. 7, the first split ring 223 urges against the bottom of the cavity 26, the second split ring 243 urges against the bottom of the receptacle 23, and the detent 24 projects out of the second hole 242 to urge against the bottom of the button 22 again. As shown in FIG. 8, it is a corresponding view of FIG. 7, the user thus can use one hand to hole the cover 21 and the other hand to put the nails 30 in the receptacle 23 for storage from an open portion of the receptacle 23. It is understood that after the nail storage operation, the user may push the cover 21 leftward (see FIG. 7) to close the magazine 20.

While the invention has been described in terms of preferred embodiments, those skilled in the art will recognize that the invention can be practiced with modifications within the spirit and scope of the appended claims.

What is claimed is:

1. A magazine of a nail gun comprising:
a receptacle for storing nails;
a cover slidably mounted on the receptacle;
a cavity formed on an uneven bottom of the cover;
a first hole formed from a top of the cover to the cavity;
an inclined surface extending from an edge of the cavity to the bottom of the cover;
a spring biased button disposed in the first hole;
a first retaining member secured to the spring biased button and urging against a bottom of the cavity so as to retain the spring biased button;
a second hole formed from a top of the receptacle to an uneven bottom thereof and being aligned with the first hole;
a spring biased detent disposed in the second hole and projecting out of the second hole to urge against a bottom of the button; and
a second retaining member secured to the spring biased detent and urging against the bottom of the receptacle so as to retain the spring biased detent;
wherein the cover is locked by the receptacle in a storage position; and
whereby pressing the spring biased button until being stopped will disengage the first retaining member from the bottom of the cavity, disengage the second retaining member from the bottom of the receptacle, and cause the detent to clear the cavity, thereby unlocking the cover.

2. The magazine of nail gun of claim 1, wherein the first hole is adjacent to a front end of the cover and the second hole is adjacent to a front end of the receptacle.

3. The magazine of nail gun of claim 1, wherein each of the first and second retaining members is a split ring.
